(19) United States
(12) Patent Application Publication
(10) Pub. No.: US 2026/0292551 A1
(43) Pub. Date: Sep. 24, 2026

(54) WAKE-UP SIGNAL BASED MEASUREMENT

(71) Applicant: NOKIA TECHNOLOGIES OY, Espoo (FI)

(72) Inventors: Jussi-Pekka KOSKINEN, Oulu (FI); Samuli Heikki TURTINEN, Ii (FI); Jorma Johannes KAIKKONEN, Oulu (FI); Chunli WU, Beijing (CN); Timo KOSKELA, Oulu (FI)

(21) Appl. No.: 19/472,383

(22) PCT Filed: Apr. 4, 2023
(86) PCT No.: PCT/CN2023/086331

§ 371 Date: Oct. 3, 2025

(51) Int. Cl. H04W 24/08; H04W 52/02

(52) U.S. Cl. CPC H04W 24/08; H04W 52/0235

(57) ABSTRACT

Embodiments of the present disclosure relate to devices, methods, apparatuses, and computer readable storage media of wake-up signal-based measurement. A first device receives, from a second device, a configuration of a wake-up signal and at least one measurement. The at least one measurement comprises at least one of Minimization of Drive Tests (MDT) related measurement or Self Organizing/Optimizing Networks (SON) related measurement. The first device performs the at least one measurement based on at least one of the configuration or a Synchronization Signal Block (SSB). In this way, the first device can perform the MDT related measurement or SON related measurement based on wake-up signal.

### FIELDS

Various example embodiments of the present disclosure generally relate to the field of telecommunication, and in particular, to methods, devices, apparatuses and computer readable storage medium for wake-up signal based measurement.

### BACKGROUND

Fifth Generation (5G) systems are designed and developed targeting for both mobile telephony and vertical use cases. Besides latency, reliability, and availability, user equipment (UE) energy efficiency is also critical to 5G. Currently, 5G devices may have to be recharged per week or day, depending on individual's usage time. In general, 5G devices consume tens of milliwatts in Radio Resource Control (RRC) idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years. Currently, UEs need to periodically wake up once per Discontinuous Reception (DRX) cycle, which dominates the power consumption in periods with no signaling or data traffic. If UEs are able to wake up only when they are addressed, e.g., by paging, power consumption could be dramatically reduced. This can be achieved by using a wake-up signal to trigger/wake-up the main radio and a separate receiver which has the ability to monitor wake-up signal with ultra-low power consumption. Main radio works for downlink reception including e.g., SSB/system information/paging/data/control signaling reception as well as for uplink transmission including e.g., data and control signaling transmission. Main radio is also responsible for cell (re)selection evaluation to ensure e.g., that the UE is camping on the best cell. Main radio can be turned off or set to (deep) sleep unless it is turned on.

### SUMMARY

In a first aspect of the present disclosure, there is provided a first device. The first device comprises at least one processor; and at least one memory storing instructions that, when executed by the at least one processor, cause the first device at least to perform: receiving, from a second device, a configuration of a wake-up signal and at least one measurement, the at least one measurement comprising at least one of Minimization of Drive Tests (MDT) related measurement or Self Organizing/Optimizing Networks (SON) related measurement; and performing the at least one measurement based on at least one of the configuration or a Synchronization Signal Block, SSB.
In a second aspect of the present disclosure, there is provided a second device. The second device comprises at least one processor; and at least one memory storing instructions that, when executed by the at least one processor, cause the second device at least to perform: transmitting, to a first device, a configuration of a wake-up signal and at least one measurement, the at least one measurement comprising at least one of MDT related measurement or SON related measurement.
In a third aspect of the present disclosure, there is provided a method. The method comprises: receiving, at a first device, from a second device, a configuration of a wake-up signal and at least one measurement, the at least one measurement comprising at least one of MDT related measurement or SON related measurement; and performing the at least one measurement based on at least one of the configuration or a Synchronization Signal Block, SSB.
In a fourth aspect of the present disclosure, there is provided a method. The method comprises: transmitting, at a second device, to a first device, a configuration of a wake-up signal and at least one measurement, the at least one measurement comprising at least one of MDT related measurement or SON related measurement.
In a fifth aspect of the present disclosure, there is provided a first apparatus. The first apparatus comprises means for receiving, from a second device, a configuration of a wake-up signal and at least one measurement, the at least one measurement comprising at least one of MDT related measurement or SON related measurement; and means for performing the at least one measurement based on at least one of the configuration or a Synchronization Signal Block, SSB.
In a sixth aspect of the present disclosure, there is provided a second apparatus. The second apparatus comprises means for transmitting, to a first device, a configuration of a wake-up signal and at least one measurement, the at least one measurement comprising at least one of MDT related measurement or SON related measurement.
In a seventh aspect of the present disclosure, there is provided a computer readable medium. The computer readable medium comprises instructions stored thereon for causing an apparatus to perform at least the method according to the third aspect.
In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A and FIG. 2B illustrate example block diagrams of operations of a first device with a wake-up receiver (WUR) according to some example embodiments of the present disclosure, respectively;

FIG. 3 illustrates an example signaling flow of a wake-up signal based measurement procedure according to some example embodiments of the present disclosure;

FIG. 4A illustrates an example flowchart of a wake-up signal based measurement process performed by a first device according to some example embodiments of the present disclosure;

FIG. 4B illustrates another example flowchart of a wake-up signal based measurement process performed by a first device according to some example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as 6G, New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As discussed above, energy efficiency is very critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle in idle/inactive and DRX cycle in connected. To meet the battery life requirements above, eDRX cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g., lower than eDRX latency.

Currently, UEs need to periodically wake up once per DRX cycle, which dominates the power consumption in periods with no signalling or data traffic. If UEs (main radio) are able to wake up only when they are triggered/addressed, e.g., by paging, power consumption could be dramatically reduced. This can be achieved by using a wake-up signal to trigger the main radio and a separate receiver which has the ability to monitor wake-up signal with ultra-low power consumption. Main radio works for downlink reception including e.g., SSB/system information/paging/data/control signaling transmission and reception as well as for uplink transmission including e.g. data and control signaling transmission. Main radio is also responsible for cell (re)selection evaluation to ensure e.g., that the UE is camping on the best cell. Main radio which can be turned off or set to (deep) sleep unless it is turned on.

The power consumption for monitoring wake-up signal depends on the wake-up signal design and the hardware module of the wake-up receiver used for signal detecting and processing.

There is a need to primarily focus on low-power wake-up signal (WUS)/WUR for power-sensitive, small form-factor devices including IoT use cases (such as industrial sensors, controllers) and wearables, as well as other use cases, e.g., Extended Reality (XR)/smart glasses, smart phones.

FIG. 1 illustrates an example communication environment 100 in which example embodiments of the present disclosure can be implemented. In the communication environment 100, a plurality of communication devices, including a first device 110 and a second device 120, can communicate with each other.

In the example of FIG. 1, the first device 110 may include a terminal device and the second device 120 may include a network device serving the terminal device. The serving area of the second device 120 may be called as a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the second device 120 may be another device than a network device. Although illustrated as a terminal device, the first device 110 may be a device other than a terminal device.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

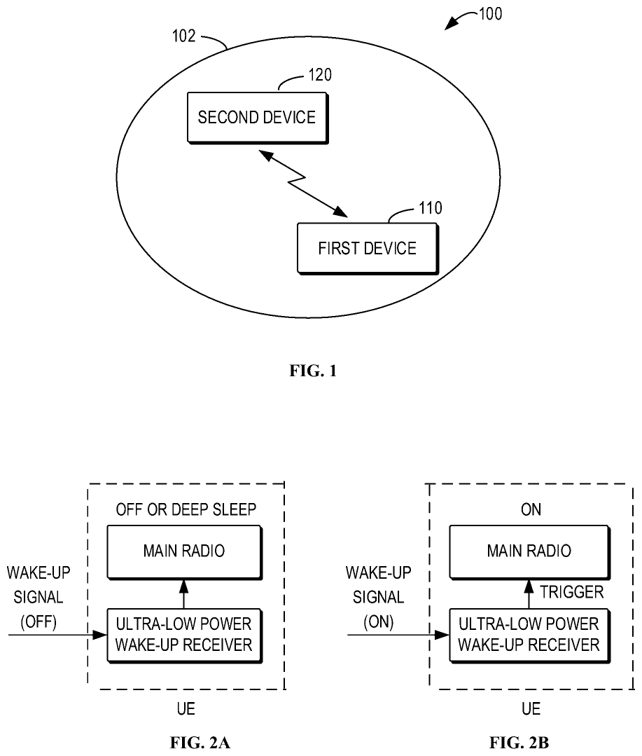

FIG. 2A and FIG. 2B illustrate example block diagrams of operations of a first device with a WUR according to some example embodiments of the present disclosure, respectively.

Considering an example of the usage of a separate low-power wake-up receiver at a terminal device, for example, a UE, and evaluate how that can reduce the UE power consumption. Generally, it is desired that the main radio of the UE can be in a sleep mode (or even powered off or in limited function state) for power saving and be activated only upon the reception of a wake-up signal (WUS) from the network, as shown in FIG. 2A. In limited function state main radio can e.g., perform relaxed cell re-selection evaluation/RRM/RLM/BFD measurements. Basically, the network, for example, a network device, triggers the UE to wake-up exactly when needed in an event-driven manner, by transmitting a special WUS to the UE, which is monitored by the dedicated low-power WUS receiver at the UE, for example, an ultra-low power receiver. When the UE receives the WUS, the WUS receiver may trigger the wake-up of the ordinary NR transceiver and communication/normal operation can start. Thus, the ultra-low power receiver wakes up the main radio, as shown in FIG. 2B. Otherwise, the main radio is OFF or kept in a deep sleep mode or kept in limited function state. The assumption is that the low-power wake-up receiver can be operated in an always ‘on’ manner with very low power consumption. In fact, it is expected that it will consume significantly less power compared to the NR transceiver, by designing a simple WUS signal and the use of dedicated hardware for its monitoring, which is only able to receive the WUS.

In example embodiments of the present disclosure, the WUS is generally refers to a Low-power WUS (LP-WUS), which is currently considered for both idle/inactive mode and connected mode. In some mechanisms, DL reception where LP-WUS can be used to wake up the main radio to receive PDCCH/PDSCH (e.g., for paging or other data) has been proposed. However, if LP-WUS based operation (e.g., paging triggering) is applied in idle/inactive mode, mobility measurements based on legacy NR signals, such as SSB, will be relaxed or omitted completely. As a result, on one hand, measurements for MDT or SON purposes will be limited or impacted by relaxation.

As one example, immediate MDT related measurement may be performed for the terminal device in a connected mode. For the terminal device in an idle mode, logged MDT needs to be used. As another example, SON related measurement relies in measurement reports from the terminal device. For example, radio link failure (RLF) reporting may be used for mobility robustness optimization (MRO) analyzing the cause of the failure with the help of RLF information coming from the terminal device. The main difference between MDT and SON is that MDT is about to collect useful information to a centralized node (Trace Collection Entity, TCE) for ‘off-line’ processing whereas SON is trying to detect the problems and make appropriate actions in ‘real time’ adjusting the system parameters with MRO the mobility (HO) parameter. Hence, by nature, SON is purely a connected state feature from the terminal device perspective.

For MDT and SON, operation(s) and mode(s) of the terminal device may affect the data provided by the terminal device and thus affect the success of the adaptation to reach optimum performance. If the terminal device is indicating preference for power optimization, the reported results can be influenced due to difference of the measurement activity compared to the ‘normal’ mode. Hence, there could be a risk that the MDT data post-processing and SON adaptation get non-ideal information leading to erroneous decisions about suitable optimization/adaptation of the parameters.

On the other hand, LP-WUS coverage measurements for MDT or SON purpose are not currently supported.

In order to solve at least part of the above problems or other potential problems, a solution on WUS based measurement is proposed. According to embodiments of the present disclosure, a first device such as a terminal device receives, from a second device such as a network device, a configuration of a WUS and at least one measurement. The at least one measurement comprises at least one of MDT related measurement or SON related measurement. The first device thus performs the at least one measurement at least based on the wake-up signal. For example, the first device may perform the at least one measurement in an inactive mode, an idle mode or a connected mode with a wake-up receiver of the first device.

By performing the MDT related measurement or SON related measurement based on the wake-up signal, MDT and SON measurement will not be impacted by the idle/inactive mode of the first device. Meanwhile, power saving can be still achieved by using such wake-up signal based MDT or SON related measurement.

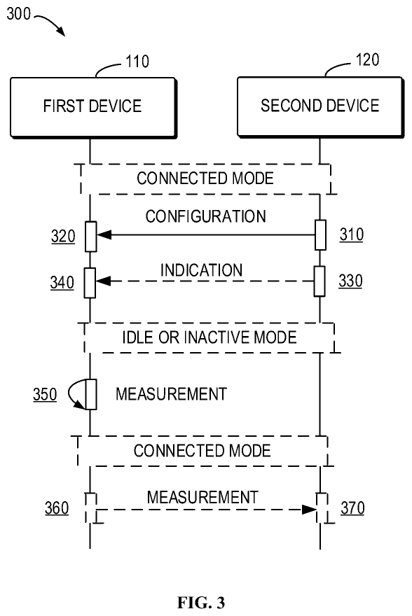

FIG. 3 illustrates an example signaling diagram 300 of a wake-up signal based measurement procedure according to some example embodiments of the present disclosure. For the purposes of discussion, the diagram 300 will be discussed with reference to FIG. 1, for example, by using the first device 110 and the second device 120.

As shown, the second device 120 transmits (310) a configuration of a wake-up signal and at least one measurement to the first device 110. The first device 110 receives (320) the configuration. By way of example, the configuration may comprise a configuration of LP-WUS and MDT and/or SON related measurement reporting.

In some example embodiments, the at least one measurement comprises an MDT related measurement (also referred to as an MDT measurement). The functionality for MDT may be introduced for both radio and operation and management (O&M) standards. By using the MDT capable device, at least part of the manual network testing can be reduced. For example, for the MDT related measurement, the first device 110 is configured report appropriate measurements result in order to allow network to collect the results and then analyze results to identify possible problems in the network or identify need for optimization of the network operation. Details regarding reporting measurements results of the MDT related measurements will be described below.

Alternatively, or in addition, in some example embodiments, the at least one measurement comprises an SON related measurement (also referred to as SON measurement). The SON functions running in the network tries to adapt the system parameters in order to achieve more optimized behavior and performance. By introducing the wake-up signal based SON related measurement, the SON functions can be maintained, and thus better behavior and performance can be achieved.

It is to be understood that these measurements are only for the purpose of illustration, without suggesting any limitations. The at least one measurement may comprise any suitable measurement.

In some embodiments, the configuration is received in a connected mode or an inactive mode. For example, the configuration may be provided via high layer (also referred to as higher layer) signaling or any other suitable signaling in the connected mode.

In some example embodiments, the first device 110 may perform (350) the at least one measurement in an inactive mode, an idle mode or a connected mode. In such cases, the second device 120 may transmit (330) an indication to the first device 110. The indication indicates to switch to the inactive or idle mode. The indication may be transmitted (330) via radio resource control (RRC) signaling. The first device 110 receives (340) the indication and thus enters the inactive or idle mode. That is, the network releases the first device 110 to RRC IDLE/INACTIVE mode. Then, the first device 110 performs (350) the at least one measurement based on at least one of the received configuration and a SSB.

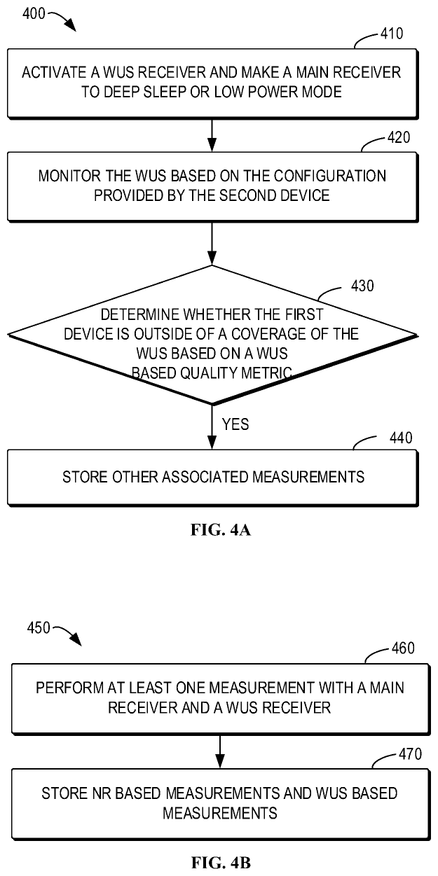

As discussed, the first device 110 performs (350) the at least one measurement in the inactive or idle mode. Several example embodiments regarding performing the measurement in the inactive or idle mode will be described with respect to FIGS. 4A-4B.

FIG. 4A illustrates a flowchart of a wake-up signal based measurement process 400 according to some example embodiments of the present disclosure. For the purpose of discussion, the process 400 will be described from the perspective of the first device 110 in FIG. 1. In the shown process 400, it is assumed that the first device 110 is currently in the idle or inactive mode. That is, LP-WUS may be configured for the first device 110. In the process 400, the first device 110 performs the at least one measurement in the inactive or idle mode with a wake-up receiver such as a LP-WUS receiver of the first device 110.

At block 410, the first device 110 may activate a wake-up signal receiver such as a LP-WUS receiver. The first device 110 may put a main receiver of the first device 110 to deep sleep, disabled mode, or low power mode. That is, in the inactive mode or in the idle mode, the wake-up receiver is activated and a main receiver of the first device 110 is disabled or in a lower power mode.

At block 420, the first device 110 may monitor the wake-up signal such as LP-WUS based on the configuration provided by the second device 120. The wake-up signal comprises at least one of a low power wake-up signal beacon or a low power synchronization signal. That is, the LP-WUS monitoring may cover monitoring a LP-WUS beacon or LP synchronization signal (LP-SS) and performing measurements with LP-WUS receiver.

At block 430, the first device 110 determines whether the first device 110 is outside of a coverage of the wake-up signal based on a wake-up signal based quality metric. For example, the wake-up signal based quality metric may be the LP-SS or any other suitable quality metric.

If the first device 110 determines that the first device 110 is outside of the coverage of the wake-up signal, at block 440, the first device 110 may store other associated measurements. For example, the first device 110 may perform a further measurement using a main receiver of the first device 110 and store the further measurement.

In some example embodiments, if the first device 110 determines, based on LP-WUS based quality or power metric (or other means), that the first device 110 is outside or close to the limit of the LP-WUS coverage (and may need to resume normal paging monitoring), the first device 110 may be configured to report or log the information related to the radio condition when/where this occurred.

In some example embodiments, the first device 110 may store information related to a current radio condition of the first device 110. The information comprises at least one of: a receiving power of a Synchronization Signal Block (SSB) such as SSB-RSRP, a location of the first device 110, a further signal quality metric, or a currently applied configuration of the wake-up signal.

As an example, the first device 110 may be configured to store at least the SS-RSRP of the associated SSB index of wake-up signal or LP-WUS. Alternatively, or in addition, the first device 110 may be configured to store SS-RSRP of one or more SSBs associated with the monitored LP-WUS.

In some example embodiments, if a reception level of the wake-up signal is below a threshold level, the fist device 110 may perform the at least one measurement on at least one SSB associated with the wake-up signal. That is, if the first device 110 determines that the wake-up signal reception level is below a threshold, the first device 110 may be configured to perform (and log) at least one measurement on the at least one associated SSB with the wake-up signal. The at least one measurement of the at least one associated SSB may then be reported.

In some example embodiments, if a reception level of the wake-up signal is change from being below a threshold level to be equal to or above the threshold level, the first device 110 may perform the at least one measurement on at least one SSB associated with the wake-up signal. That is, if the first device 110 determines that the LP-WUS reception level is equal or above a quality threshold (after it has dropped below the threshold), it may be configured to perform (and log) at least one measurement on the at least one associated SSB with the wake-up signal.

In some example embodiments, if a reception level of the wake-up signal is below a threshold level, the first device 110 may perform the at least one measurement on at least one SSB of a cell associated with the wake-up signal. A measurement result of a predetermined number of receiving powers of SSBs may be stored. That is, if the first device 110 determines that the LP-WUS reception level is below a threshold, the first device 110 may be configured to perform (and log) at least one measurement on the at least one SSB of the cell associated with the wake-up signal and log the measurement result of N-highest SS-RSRP (N being an integer).

By performing such measurements based on wake-up signal, the MDT and/or SON related measurements can be performed while the first device 110 is in an idle or inactive mode.

As discussed above, at block 430, the first determines whether the first device 110 is outside of the coverage of the wake-up signal. In some example embodiments, the first device 110 may use a quality metric to determine the LP-WUS coverage. Examples of the quality metric includes but not limited to: the wake-up signal or message itself, such as a preamble of the LP-WUS or a sync part of the LP-WUS, if sent semi-/periodically, or separate LP beacon such as LP synchronization signal that is sent semi-/periodically, or any combination thereof. The quality metric may be defined. The threshold for determining the coverage may also be configured or determined by the first device 110.

In this way, the LP-WUS related measurement metric such as a quality metric based on possible sync part of the LP-WUS message can be used by the first device 110 to determine or estimate the coverage area of the LP-WUS operation. This can be done in an autonomous manner of the first device 110, based on internal thresholds related to the LP-WUR performance or based on network configured thresholds, either to LP-WUS related measurement metric or to MR related metric.

By determining the coverage area of the wake-up signal, the LP-WUS coverage related information can be determined and stored. Such information may be reported to the network to improve network deployment and configurations.

Example embodiments regarding the wake-up signal based measurements have been described above. With the wake-up signal based measurements, MDT and SON related measurements will not be affected due to the first device in LP-WUS mode or idle/inactive mode. In addition, power saving can be still attained while MDT or SON measurements are configured. Further example embodiments regarding the wake-up signal based measurements will be described with respect to FIG. 4B.

FIG. 4B illustrates a flowchart of a wake-up signal based measurement process 450 according to some example embodiments of the present disclosure. For the purpose of discussion, the process 450 will be described from the perspective of the first device 110 in FIG. 1. In the shown process 450, it is assumed that the first device 110 is currently in the idle or inactive mode. That is, LP-WUS may be configured for the first device 110.

At block 460, the first device 110 may performs the at least one measurement in the inactive or idle mode with a wake-up receiver such as a LP-WUS receiver of the first device 110 and a main receiver of the first device 110.

If the at least one measurement is configured to cover a legacy measurement and a wake-up signal related measurement, the main receiver may be activated. That is, in example embodiments where the first device 110 performing the at least one measurement with the wake-up receiver and the main receiver, the main receiver may be activated to perform measurement. The main receiver may be activated more frequently. The first device 110 may perform the legacy measurement and the wake-up signal related measurement in the inactive mode or the idle mode. The legacy measurement may be a measurement obtained based on legacy NR signal(s). For example, the legacy measurement may be a Synchronization Signal Block, SSB, based measurement.

During the at least one measurement with the wake-up receiver, the first device 110 may monitor the wake-up signal based on the configuration. The wake-up signal comprises at least one of a low power wake-up signal beacon such as a LP-WUS beacon or a low power synchronization signal such as LP-SS. For the at least one measurement with the main receiver, the first device 110 may monitor NR based measurements such as SSB-RSRP.

At block 470, the first device 110 may store NR based measurements and wake-up signal based or LP-WUS based measurements. For example, SSB-RSRP and LP-WUS based measurement metrics may be stored. For another example, SS-RSRP of the SSB index associated with the LP-WUS monitoring may be stored.

In some example embodiments, the first device 110 may be configured to apply both LP-WUR and main receiver if the first device 110 is close to the limit of the LP-WUS coverage (e.g., based on LP-WUR measurements). The first device 110 may determine, log, and report whether the LP-WUS may be decoded whenever paging is received with the main receiver. For both options of only LP-WUR or also main receiver is used to determine LP-WUS coverage, SSB-RSRP, location or other signaling metrics can be logged when the first device 110 moves in or out of the LP-WUS coverage when the switching happens. Furthermore, the measurement results of both the LP-WUR and main receiver upon the switch may be logged/reported.

By performing the measurements with the wake-up receiver and main receiver, both LP-WUS based measurement metric and other NR based metric such as SSB-RSRP can be stored or logged together. With the measurements with the wake-up receiver and main receiver, MDT and SON related measurements will not be affected due to the first device in LP-WUS mode or idle/inactive mode. In addition, power saving can be still attained while MDT or SON measurements are configured.

Examples of the at least one measurement performed based on the configuration related to the wake-up signal have been described with respect to FIGS. 4A-4B. Now reference is back to FIG. 3. The fist device 110 may transmit (360) information about the at least one measurement to the second device 120. The information may comprise at least one of an indication of availability of the at least one measurement, a further indication of availability of a wake-up signal related measurement, a receiving power of a Synchronization Signal Block, SSB, index associated with monitoring of the wake-up signal, a receiving power of at least one SSB associated with the wake-up signal, a coverage difference between the wake-up signal and the SSB, whether the wake-up signal is configured during performing the at least one measurement, or whether NR measurements are relaxed due to the wake-up signal. The second device 120 may receive (370) the information.

By comprising the indication of availability of the at least one measurement, the first device 110 can indicate in the measurement report or measurement logs that NR based results were omitted/impacted due to the LP-WUS based measurement relaxation or operation. This allows the first device 110 to preserve power as doing main receiver based measurements are not required even for MDT logging.

In some example embodiments, the first device 110 may be switched to the connected mode. If the first device 110 enters the connected mode from the inactive or idle mode, the first device 110 transmits (360) the information about the at least one measurement to the second device 120.

As an example, the information (also referred to as the transmitted information or reported information) may further comprise a further indication of availability of a wake-up signal related measurement. As another example, the information may further comprise measurement information or quality metric stored during the measurement.

In example embodiments where the first device 110 storing the receiving power of a SSB index associated with monitoring of the wake-up signal such as the SS-RSRP of the associated SSB index of wake-up signal or LP-WUS during the measurements, the transmitted information may comprise the receiving power of the SSB index associated with monitoring of the wake-up signal. Alternatively, or in addition, the first device 110 may be configured to transmit information of SS-RSRP of one or more SSBs associated with the monitored LP-WUS.

In example embodiments where the first device 110 performing (and log) at least one measurement on the at least one associated SSB with the wake-up signal, the transmitted information may comprise a receiving power of the at least one SSB associated with the wake-up signal. As one example, the receiving power of the at least one SSB associated with the wake-up signal may comprise the measurement result of N-highest SS-RSRP (N being an integer).

In some example embodiments, the information may further comprise a coverage difference between the wake-up signal and the SSB. For example, the first device 110 may determine, log, and report how much there is coverage difference (for example, in dBs or meters based on positioning) between LP-WUS and NR based signal (such as SSB).

In some example embodiments, the information may further comprise whether the wake-up signal is configured during performing the at least one measurement. That is, the terminal device 110 may indicate in the NR SON/MDT measurement report or measurement logs that wake-up signal based measurements or LP-WUS was configured during the measurements.

Alternatively, or in addition, in some example embodiments, the information may further comprise whether NR measurements are relaxed due to the wake-up signal. For example, the first device 110 may indicate in the NR SON/MDT measurement report or measurement logs whether NR measurements were relaxed or not due to wake-up signal or LP-WUS.

In some examples, the first device 110 may transmit, to the second device 120, an indication that a legacy measurement (also referred to as legacy NR based signal measurement) is relaxed or omitted due to a wake-up signal related measurement. In such cases, the second device 120 may not configure legacy MDT or SON measurement for the first device 110 which is configured with LP-WUS.

It would be appreciated that some example specifications and embodiments are provided above, and the detailed description may be varied.

Example embodiments for wake-up signal based measurement are described above with reference to the signaling flow 200, and processes 400 and 450. In some embodiments, embodiments described with reference to two or more of the above signaling flows and processed may be combined. By using these signaling flows and/or processes, the wake-up signal based measurements can be configured and performed. Information regarding the measurement can be transmitted to the network, MDT and SON related measurements can be performed while the first device in an idle or inactive mode. In addition, coverage information of the wake-up signal can be logged or reported to the network. The network deployment and configurations can thus be improved. Moreover, power saving can be still achieved while the wake-up signal based measurements are performed.

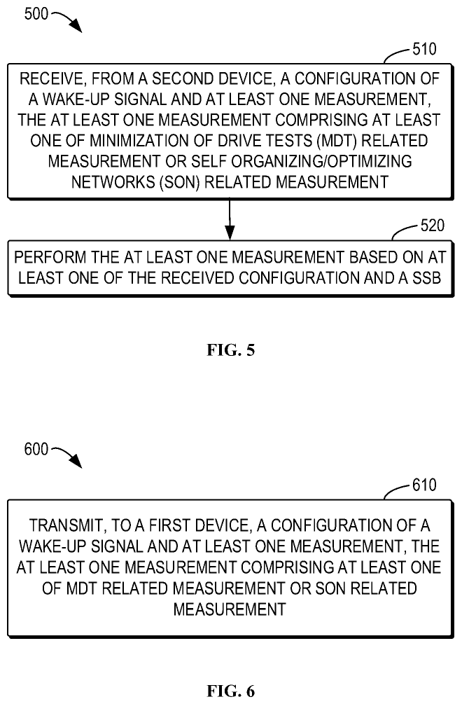

FIG. 5 shows a flowchart of an example method 500 implemented at a first device in accordance with some example embodiments of the present disclosure. For the purpose of discussion, the method 500 will be described from the perspective of the first device 110 in FIG. 1.

At block 510, the first device 110 receives, from a second device such as the device 120, a configuration of a wake-up signal and at least one measurement. The at least one measurement comprises at least one of Minimization of Drive Tests, MDT, related measurement or Self Organizing/Optimizing Networks, SON, related measurement.

At block 520, the first device 110 performs the at least one measurement at least based on the wake-up signal.

In some example embodiments, the configuration is received in a connected mode or an inactive mode.

In some example embodiments, the first device 110 may perform the at least one measurement in an inactive mode, an idle mode or a connected mode with a wake-up receiver of the first device. In the active mode or in the idle mode, the wake-up receiver is activated and a main receiver of the first device is disabled or in a lower power mode.

In some example embodiments, the first device 110 may monitor the wake-up signal based on the configuration. The wake-up signal comprises at least one of a low power wake-up signal beacon or a low power synchronization signal.

In some example embodiments, the first device 110 may determine whether the first device 110 is outside of a coverage of the wake-up signal based on a wake-up signal based quality metric. If the first device 110 is outside of the coverage of the wake-up signal, the first device 110 may perform a further measurement using a main receiver of the first device.

In some example embodiments, the first device 110 may store information related to a current radio condition of the first device 110. The information comprises at least one of: a receiving power of a Synchronization Signal Block, SSB, a location of the first device 110, a further signal quality metric, or a currently applied configuration of the wake-up signal.

In some example embodiments, the first device 110 may perform the at least one measurement in an inactive mode, an idle mode or a connected mode with a main receiver and a wake-up receiver of the first device 110.

In some example embodiments, if the at least one measurement is configured to cover a legacy measurement and a wake-up signal related measurement, the main receiver is activated.

In some example embodiments, the first device 110 may perform the legacy measurement and the wake-up signal related measurement in the inactive mode or the idle mode.

In some example embodiments, the first device 110 may monitor the wake-up signal based on the configuration. The wake-up signal comprises at least one of a low power wake-up signal beacon or a low power synchronization signal.

In some example embodiments, the first device 110 may transmit, to the second device, information about the at least one measurement. The information comprises at least one of an indication of availability of the at least one measurement, a further indication of availability of a wake-up signal related measurement, a receiving power of a Synchronization Signal Block, SSB, index associated with monitoring of the wake-up signal, a receiving power of at least one SSB associated with the wake-up signal, a coverage difference between the wake-up signal and the SSB, whether the wake-up signal is configured during performing the at least one measurement, or whether NR measurements are relaxed due to the wake-up signal.

In some example embodiments, if the first device 110 enters a connected mode from an inactive mode or an idle mode, the first device 110 may transmit the information about the at least one measurement to the second device.

In some example embodiments, the first device 110 may transmit, to the second device, an indication that a legacy measurement is relaxed or omitted due to a wake-up signal related measurement.

In some example embodiments, the legacy measurement is SSB based measurement.

In some example embodiments, if a reception level of the wake-up signal is below a threshold level, the first device 110 may perform at least one measurement on at least one Synchronization Signal Block, SSB, associated with the wake-up signal. If a reception level of the wake-up signal is change from being below a threshold level to be equal to or above the threshold level, the first device 110 may perform at least one measurement on at least one Synchronization Signal Block, SSB, associated with the wake-up signal. Alternatively, or in addition, if a reception level of the wake-up signal is below a threshold level, the first device 110 may perform at least one measurement on at least one Synchronization Signal Block, SSB, of a cell associated with the wake-up signal. The first device 110 may store a measurement result of a predetermined number of receiving powers of SSBs.

FIG. 6 shows a flowchart of an example method 600 implemented at a second device in accordance with some example embodiments of the present disclosure. For the purpose of discussion, the method 600 will be described from the perspective of the second device 120 in FIG. 1.

At block 610, the second device 120 transmits, to a first device such as the first device 110, a configuration of a wake-up signal and at least one measurement. The at least one measurement comprises at least one of Minimization of Drive Tests, MDT, related measurement or Self Organizing/Optimizing Networks, SON, related measurement.

In some example embodiments, the configuration is transmitted in a connected mode or an inactive mode.

In some example embodiments, the second device 120 may receive, from the first device, information about the at least one measurement. The information may comprise an indication of availability of the at least one measurement, a further indication of availability of a wake-up signal related measurement, a receiving power of a Synchronization Signal Block, SSB, index associated with monitoring of the wake-up signal, a receiving power of at least one SSB associated with the wake-up signal, a coverage difference between the wake-up signal and the SSB, whether the wake-up signal is configured during performing the at least one measurement, or whether NR measurements are relaxed due to the wake-up signal.

In some example embodiments, if the first device enters a connected mode from an inactive mode or an idle mode, the second device 120 may receive the information about the at least one measurement to the second device.

In some example embodiments, the second device 120 may receive, from the second device, an indication that a legacy measurement is relaxed or omitted due to a wake-up signal related measurement.

In some example embodiments, a first apparatus capable of performing any of the method 500 (for example, the first device 110 in FIG. 1 may comprise means for performing the respective operations of the method 500. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a second device, a configuration of a wake-up signal and at least one measurement, the at least one measurement comprising at least one of Minimization of Drive Tests, MDT, related measurement or Self Organizing/Optimizing Networks, SON, related measurement; and means for performing the at least one measurement based on at least one of the configuration or a Synchronization Signal Block, SSB.

In some example embodiments, the configuration is received in a connected mode or an inactive mode.

In some example embodiments, means for performing the at least one measurement comprises: means for performing the at least one measurement in an inactive mode, an idle mode or a connected mode with a wake-up receiver of the first device, wherein in the inactive mode or in the idle mode, the wake-up receiver is activated and a main receiver of the first device is disabled or in a lower power mode.

In some example embodiments, means for performing the at least one measurement comprises: means for monitoring the wake-up signal based on the configuration, the wake-up signal comprising at least one of a low power wake-up signal beacon or a low power synchronization signal.

In some example embodiments, the first apparatus further comprises: means for determining whether the first device is outside of a coverage of the wake-up signal based on a wake-up signal based quality metric; and means for in accordance with a determination that the first device is outside of the coverage of the wake-up signal, performing a further measurement using a main receiver of the first device.

In some example embodiments, the first apparatus further comprises: means for storing information related to a current radio condition of the first device, the information comprising at least one of: a receiving power of a Synchronization Signal Block, SSB, a location of the first device, a further signal quality metric, or a currently applied configuration of the wake-up signal.

In some example embodiments, means for performing the at least one measurement comprises: means for performing the at least one measurement in an inactive mode, an idle mode or a connected mode with a main receiver and a wake-up receiver of the first device.

In some example embodiments, if the at least one measurement is configured to cover a legacy measurement and a wake-up signal related measurement, the main receiver is activated.

In some example embodiments, means for performing the at least one measurement comprises: means for performing the legacy measurement and the wake-up signal related measurement in the inactive mode or the idle mode.

In some example embodiments, means for performing the at least one measurement comprises: means for monitoring the wake-up signal based on the configuration, the wake-up signal comprising at least one of a low power wake-up signal beacon or a low power synchronization signal.

In some example embodiments, the first apparatus further comprises: means for transmitting, to the second device, information about the at least one measurement, the information may comprise at least one of an indication of availability of the at least one measurement, a further indication of availability of a wake-up signal related measurement, a receiving power of a Synchronization Signal Block, SSB, index associated with monitoring of the wake-up signal, a receiving power of at least one SSB associated with the wake-up signal, a coverage difference between the wake-up signal and the SSB, whether the wake-up signal is configured during performing the at least one measurement, or whether NR measurements are relaxed due to the wake-up signal.

In some example embodiments, means for transmitting the information about the at least one measurement comprises: means for in accordance with a determination that the first device enters a connected mode from an inactive mode or an idle mode, transmitting the information about the at least one measurement to the second device.

In some example embodiments, the first apparatus further comprises: means for transmitting, to the second device, an indication that a legacy measurement is relaxed or omitted due to a wake-up signal related measurement.

In some example embodiments, the legacy measurement is SSB based measurement.

In some example embodiments, the first apparatus further comprises: means for in accordance with a determination that a reception level of the wake-up signal is below a threshold level, performing at least one measurement on at least one Synchronization Signal Block, SSB, associated with the wake-up signal, means for in accordance with a determination that a reception level of the wake-up signal is change from being below a threshold level to be equal to or above the threshold level, performing at least one measurement on at least one Synchronization Signal Block, SSB, associated with the wake-up signal, or means for in accordance with a determination that a reception level of the wake-up signal is below a threshold level, performing at least one measurement on at least one Synchronization Signal Block, SSB, of a cell associated with the wake-up signal, and storing a measurement result of a predetermined number of receiving powers of SSBs.

In some example embodiments, the first apparatus further comprises means for performing other operations in some example embodiments of the method 500 or the first device 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second device 120 in FIG. 1) may comprise means for performing the respective operations of the method 600. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a first device, a configuration of a wake-up signal and at least one measurement, the at least one measurement comprising at least one of Minimization of Drive Tests, MDT, related measurement or Self Organizing/Optimizing Networks, SON, related measurement.

In some example embodiments, the configuration is transmitted in a connected mode or an inactive mode.

In some example embodiments, the second apparatus further comprises: means for receiving, from the first device, information about the at least one measurement, the information may comprise at least one of an indication of availability of the at least one measurement, a further indication of availability of a wake-up signal related measurement, a receiving power of a Synchronization Signal Block, SSB, index associated with monitoring of the wake-up signal, a receiving power of at least one SSB associated with the wake-up signal, a coverage difference between the wake-up signal and the SSB, whether the wake-up signal is configured during performing the at least one measurement, or whether NR measurements are relaxed due to the wake-up signal.

In some example embodiments, means for receiving the information about the at least one measurement comprises: means for in accordance with a determination that the first device enters a connected mode from an inactive mode or an idle mode, receiving the information about the at least one measurement to the second device.

In some example embodiments, the second apparatus further comprises: means for receiving, from the second device, an indication that a legacy measurement is relaxed or omitted due to a wake-up signal related measurement.

In some example embodiments, the second apparatus further comprises means for performing other operations in some example embodiments of the method 600 or the second device 120. In some example embodiments, the means comprises at least one processor; and at least one memory storing instructions that, when executed by the at least one processor, cause the performance of the second apparatus.

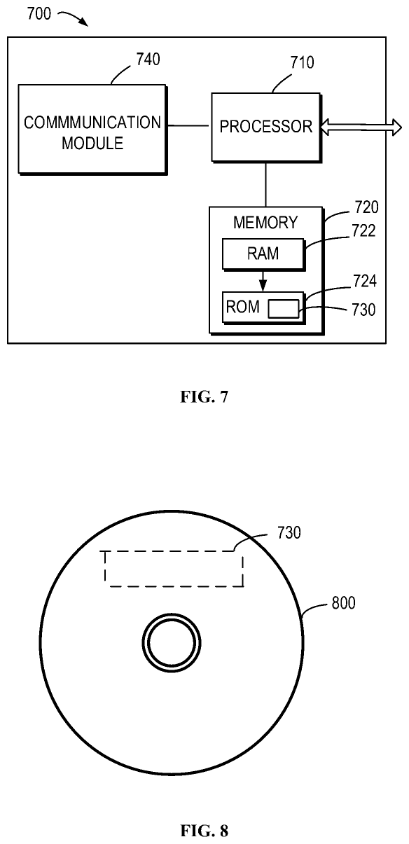

FIG. 7 is a simplified block diagram of a device 700 that is suitable for implementing example embodiments of the present disclosure. The device 700 may be provided to implement a communication device, for example, the first device 110 or the second device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 3 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

### PARTIAL GLOSSARY

UE User Equipment
5G Fifth Generation
RAN Radio Access Network
LTE Long Term Evolution
LTE-A LTE-Advanced
WCDMA Wideband Code Division Multiple Access
HSPA High-Speed Packet Access
NB-IoT Narrow Band Internet of Things
NR New Radio
BS Base Station
AP Access Point
eNodeB Evolved NodeB
gNB/NR NB Next Generation NodeB
RRU Remote Radio Unit
RH Radio Header
RRH Remote Radio Head
CU Centralized Unit
DU Distributed Unit
SS Subscriber Station
MS Mobile Station
AT Access Terminal
VOIP Voice over IP
PDA Personal Digital Assistant
LEE Laptop-embedded Equipment
LME Laptop-mounted Equipment
USB Universal Serial Bus
CPE Customer-Premises Equipment
HMD Head-mounted Display
MT Mobile Termination
IAB Integrated Access and Backhaul
DL Downlink
UL Uplink
Tx Transmitting
Rx Receiving
ID Identity/Identifier
IEEE Institute for Electrical and Electronics Engineers
CDMA Code Division Multiple Access
FDMA Frequency Division Multiple Access
TDMA Time Division Multiple Access
FDD Frequency Division Duplex
TDD Time Division Duplex
MIMO Multiple-Input Multiple-Output
OFDM Orthogonal Frequency Division Multiple
DFT-s-OFDM Discrete Fourier Transform spread OFDM
IoT Internet of everything
eMTC enhanced Machine-Type Communication
URLLC Ultra Reliable Low Latency Communications
eMBB Enhanced Mobile Broadband
mMTC Massive Machine Type Communications
RRC Radio Resource Control
DRX Discontinuous Reception
WUR wake-up receiver
WUS wake-up signal
LP-WUS low-power WUS
XR Extended Reality
SIB System Information Block
RSRP Reference Signal Receiving Power
RRM Radio Resource Management
RLM Radio Link Monitoring
BFD Beam Failure Detection
PO paging occasion
PDCCH Physical Downlink Control Channel

1. A first device comprising:
at least one processor; and
at least one memory storing instructions that, when executed by the at least one processor, cause the first device at least to perform:
receiving, from a second device, a configuration of a wake-up signal and at least one measurement, the at least one measurement comprising at least one of Minimization of Drive Tests, MDT, related measurement or Self Organizing/Optimizing Networks, SON, related measurement; and
performing the at least one measurement based on at least one of the configuration or a Synchronization Signal Block, SSB.

2. The first device of claim 1, wherein the configuration is received in a connected mode or an inactive mode.

3. The first device of claim 1, wherein performing the at least one measurement comprises:
performing the at least one measurement in an inactive mode, an idle mode or a connected mode with a wake-up receiver of the first device, wherein in the inactive mode or in the idle mode, the wake-up receiver is activated and a main receiver of the first device is disabled or in a lower power mode.

4. The first device of claim 3, wherein performing the at least one measurement comprises:
monitoring the wake-up signal based on the configuration, the wake-up signal comprising at least one of a low power wake-up signal beacon or a low power synchronization signal.

5. The first device of claim 1, wherein the first device is further caused to perform:
determining whether the first device is outside of a coverage of the wake-up signal based on a wake-up signal based quality metric; and
in accordance with a determination that the first device is outside of the coverage of the wake-up signal, performing a further measurement using a main receiver of the first device.

6. The first device of claim 5, wherein the first device is further caused to perform:
storing information related to a current radio condition of the first device, the information comprising at least one of: a receiving power of a Synchronization Signal Block, SSB, a location of the first device, a further signal quality metric, or a currently applied configuration of the wake-up signal.

7. The first device of claim 1, wherein performing the at least one measurement comprises:
performing the at least one measurement in an inactive mode, an idle mode or a connected mode with a main receiver and a wake-up receiver of the first device.

8. The first device of claim 7, wherein if the at least one measurement is configured to cover a legacy measurement and a wake-up signal related measurement, the main receiver is activated.

9. The first device of claim 8, wherein performing the at least one measurement comprises:
performing the legacy measurement and the wake-up signal related measurement in the inactive mode or the idle mode.

10. The first device of claim 7, wherein performing the at least one measurement comprises:
monitoring the wake-up signal based on the configuration, the wake-up signal comprising at least one of a low power wake-up signal beacon or a low power synchronization signal.

11. The first device of claim 1, wherein the first device is further caused to perform:
transmitting, to the second device, information about the at least one measurement, the information comprising at least one of:
an indication of availability of the at least one measurement,
a further indication of availability of a wake-up signal related measurement,
a receiving power of a Synchronization Signal Block, SSB, index associated with monitoring of the wake-up signal,
a receiving power of at least one SSB associated with the wake-up signal,
a coverage difference between the wake-up signal and the SSB,
whether the wake-up signal is configured during performing the at least one measurement, or
whether NR measurements are relaxed due to the wake-up signal.

12. The first device of claim 11, wherein transmitting the information about the at least one measurement comprises:
in accordance with a determination that the first device enters a connected mode from an inactive mode or an idle mode, transmitting the information about the at least one measurement to the second device.

13. The first device of claim 1, wherein the first device is further caused to perform:
transmitting, to the second device, an indication that a legacy measurement is relaxed or omitted due to a wake-up signal related measurement.

14. The first device of claim 8, wherein the legacy measurement is Synchronization Signal Block, SSB, based measurement.

15. The first device of claim 1, wherein the first device is further caused to perform at least one of:
in accordance with a determination that a reception level of the wake-up signal is below a threshold level, performing at least one measurement on at least one Synchronization Signal Block, SSB, associated with the wake-up signal,
in accordance with a determination that a reception level of the wake-up signal is change from being below a threshold level to be equal to or above the threshold level, performing at least one measurement on at least one Synchronization Signal Block, SSB, associated with the wake-up signal, or
in accordance with a determination that a reception level of the wake-up signal is below a threshold level, performing at least one measurement on at least one Synchronization Signal Block, SSB, of a cell associated with the wake-up signal, and storing a measurement result of a predetermined number of receiving powers of SSBs.

16. A second device comprising:
at least one processor; and
at least one memory storing instructions that, when executed by the at least one processor, cause the second device at least to perform:
transmitting, to a first device, a configuration of a wake-up signal and at least one measurement, the at least one measurement comprising at least one of Minimization of Drive Tests, MDT, related measurement or Self Organizing/Optimizing Networks, SON, related measurement.

17. The second device of claim 16, wherein the configuration is transmitted in a connected mode or an inactive mode.

18. The second device of claim 16, wherein the second device is further caused to perform:
receiving, from the first device, information about the at least one measurement, the information comprising at least one of:
an indication of availability of the at least one measurement,
a further indication of availability of a wake-up signal related measurement,
a receiving power of a Synchronization Signal Block, SSB, index associated with monitoring of the wake-up signal,
a receiving power of at least one SSB associated with the wake-up signal,
a coverage difference between the wake-up signal and the SSB,
whether the wake-up signal is configured during performing the at least one measurement, or
whether NR measurements are relaxed due to the wake-up signal.

19. The second device of claim 18, wherein receiving the information about the at least one measurement comprises:
in accordance with a determination that the first device enters a connected mode from an inactive mode or an idle mode, receiving the information about the at least one measurement to the second device.

20. The second device of claim 16, wherein the second device is further caused to perform:
receiving, from the second device, an indication that a legacy measurement is relaxed or omitted due to a wake-up signal related measurement.

21. The first device of claim 20, wherein the legacy measurement is Synchronization Signal Block, SSB, based measurement.

22. A method comprising:
receiving, at a first device, from a second device, a configuration of a wake-up signal and at least one measurement, the at least one measurement comprising at least one of Minimization of Drive Tests, MDT, related measurement or Self Organizing/Optimizing Networks, SON, related measurement; and
performing the at least one measurement based on at least one of the configuration or a Synchronization Signal Block, SSB.

23. A method comprising:
transmitting, at a second device, to a first device, a configuration of a wake-up signal and at least one measurement, the at least one measurement comprising at least one of Minimization of Drive Tests, MDT, related measurement or Self Organizing/Optimizing Networks, SON, related measurement.

24. (canceled)

25. (canceled)

26. (canceled)
